(19) United States
(12) Patent Application Publication
(10) Pub. No.: US 2026/0252047 A1
(43) Pub. Date: Aug. 27, 2026

(54) Intelligent Context-Aware Smart Home Management System

(71) Applicant: Wei Tung William TAI, Hong Kong (HK)

(72) Inventor: Wei Tung William TAI, Hong Kong (HK)

(21) Appl. No.: 19/059,305

(22) Filed: Feb. 21, 2025

(51) Int. Cl. G05B 15/02

(52) U.S. Cl. CPC G05B 15/02

(57) ABSTRACT

The present disclosure introduces an Intelligent Context-Aware Smart Home Management System designed to proactively adjust smart home settings, leveraging both historical and real-time data to offer personalized, anticipatory support. By integrating advanced machine learning techniques, the system dynamically predicts and fulfills user needs through context-aware assistance. Central to this innovation are three key recognizers: wake-word detection, dynamic transcription, and relevance-based scene recognition, working in tandem to activate and provide precise, timely assistance based on the user's immediate context and preferences. An autonomous decision-making module evaluates context relevance, selects optimal scenes, and implements necessary commands across interconnected smart home devices, significantly enhancing user experience.

### FIELD OF INVENTION

This specification relates generally to leveraging machine learning techniques on diverse data sets for enhanced optimization purposes.

### BACKGROUND OF THE INVENTION

The advancement of smart home technology has dramatically altered how users interact with their environments, providing levels of convenience, security, and personalization previously unattainable. Historically, these systems have predominantly utilized command vocabulary-based interfaces, requiring users to articulate specific verbal commands for device control. While this method serves well for direct manipulation, it often falls short in flexibility and the ability to foresee user needs for proactive support. Against this backdrop, the introduction of a relevance-based assistance prediction system marks a substantial innovation.

Traditional command vocabulary systems, despite being foundational, face notable challenges. First, they necessitate users memorizing specific commands, which can hinder natural interaction and pose a learning curve for newcomers. Moreover, these systems operate reactively, relying solely on direct user commands without factoring in the user's contextual environment, habits, or preferences. This reactive nature limits the system's capacity for delivering personalized, anticipatory assistance, thereby diminishing user satisfaction and system engagement.

In response to these challenges, the shift towards facilitating more natural, conversational interactions between users and their smart home systems emerges as a crucial development. By moving beyond the constraints of fixed command vocabularies, this approach not only elevates user satisfaction but also broadens the utility of smart home technologies, making them more accessible and appealing to a wider audience. This evolution underscores the necessity for a system that not only responds to direct commands but also intelligently anticipates and addresses user needs through a deep understanding of context and user behavior, and most importantly, learn from it—the user behavior and its surrounding environment, in order to reduce wrong detection rates.

### SUMMARY OF THE INVENTION

The present disclosure introduces a sophisticated relevance-based assistance prediction system, uniquely designed to enhance user interaction through the integration of three advanced recognizers: wake-word detection, dynamic transcription, and relevance-based scene recognition. This triad of recognizers works in concert to activate and provide assistance that is aligned with the user's current context and needs. By emphasizing the relevance of assistance, the invention offers an intuitive, efficient, and contextually appropriate response mechanism, significantly improving the user experience across diverse environments and applications.

The present disclosure comprises a machine learning assistance prediction system that dynamically integrates and analyzes data from an array of external databases and sensor data sources. Utilizing a variety of advanced machine learning techniques, such as random forest classifiers, gradient boosting, and neural networks, the system is adept at predicting the relevance of assistance in real-time and across a multitude of scenarios. This predictive model is designed to continuously update with new data, ensuring its ongoing accuracy and relevance.

The system leverages the wake-word and dynamic transcription recognizers for initial engagement, while the relevance-based scene recognizer assesses the contextual appropriateness of assistance. This unique approach ensures that assistance is relevant to the user's immediate context and conditions.

The system seamlessly integrates both historical and real-time data from diverse sources into the predictive model. This holistic approach to data analysis allows the system to make well-informed predictions, taking into account a broad spectrum of influencing factors and thereby enhancing the precision of assistance relevance predictions.

Moreover, the predictive models within the system are inherently adaptive, evolving over time with the incorporation of new data. This dynamic feature ensures the system's continued efficacy and relevance, even as external conditions and user needs change.

Beyond its predictive capabilities, the invention identifies and recommends optimal scenes for execution, tailored to the user's preferences and the predicted relevance of assistance. These recommendations represent a harmonious blend of advanced predictive insights and personalized user preferences, culminating in a highly personalized and effective assistance experience.

The present disclosure marries the capabilities of wake-word detection, dynamic transcription, and relevance-based scene recognition, and optimizing scene execution based on comprehensive data analysis.

### BRIEF DESCRIPTIONS OF DRAWINGS

FIG. 1 is a block diagram of a system environment in which a machine learning assistance relevance prediction system operates, according to various embodiments.

FIG. 2 illustrates an example device capability database for a machine learning assistance relevance prediction system.

FIG. 3 illustrates an example user behavioral database for a machine learning assistance relevance system.

FIG. 4 is a block diagram of a machine learning assistance relevance prediction engine, according to various embodiments.

FIG. 5 is a flowchart illustrating a process for integrating a prediction engine with a relevance-based scene recognizer to optimize smart home environment settings based on user behavior and environmental data.

FIG. 6 is a flowchart illustrating a process for Mode Transition and Scene Recognizer Management.

### DETAILED DESCRIPTION

The present disclosure depicts an advanced relevance-based assistance prediction system, the system comprises three recognizers: wake-word detection, dynamic transcription, and relevance-based scene recognition. An autonomous decision-making module 110 assesses context relevance, selects appropriate scenes, and executes commands across an interconnected network of Smart Home devices. The present disclosure empowers users to craft routines, such as predefined sets of actions activated by specific events or times, such as a morning routine that illuminates the home and plays music upon a simple vocal prompt. Furthermore, it introduces the concept of scenes, which are comprehensive settings adjustments across multiple devices, like a “Movie Night” scene that effortlessly dims lights, activates the television, and adjusts the thermostat for an ideal viewing ambiance. These scenes, alongside individual device actions like illuminating a room, are readily activated through a variety of triggers seamlessly integrating into the user's daily life and preferences.

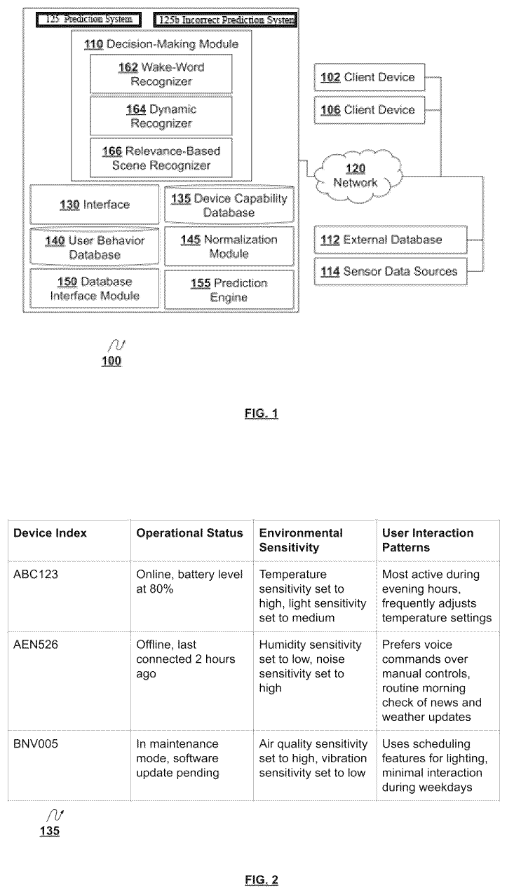

FIG. 1 is a block diagram of a system environment 100 in which a machine learning assistance prediction system operates. The system environment 100 shown in FIG. 1 includes an admin client device 102, a user client device 106, external databases 112, sensor data sources 114, and the assistance prediction system 125. In alternative configurations, different, additional, and/or fewer components may be included in the system environment 100. For instance, one or more of the components illustrated in FIG. 1 may be implemented within the same computing device.

A routine is a set of actions that are triggered by a specific event or time. Routines can be customized to specific needs and preferences.

A scene is a collection of settings that are applied to smart home devices all at once. Scenes can be activated by a variety of triggers, such as a voice command, a button press, or a motion sensor.

An action is a single command that is sent to a smart home device. For example, a user could create an action that turns on the lights in the living room. Actions can be triggered by a variety of events, such as a voice command, a button press, or a motion sensor.

Scenes are one of the tools through which assistance can be delivered. For example, the system might recognize (through its predictive capabilities) that a user is about to start their workday based on the time and their historical behavior. As assistance, it could suggest or automatically activate the “Work Mode” scene.

While a scene is a specific configuration of actions and settings, assistance encompasses a broader range of support mechanisms, including but not limited to recommending or activating scenes. Assistance uses predictive analytics to make those decisions.

In Command Mode, the assistance prediction system features a wake-word recognizer 162 that focuses solely on detecting a predefined wake-up word or phrase, thanks to its limited, fixed vocabulary. This recognizer is dedicated to continuously scanning for the wake-up command, activating command processing upon its identification.

Additionally, within Command Mode, the system is equipped with a dynamic recognizer 164. This component is tailored with a specialized, fixed vocabulary for the ongoing analysis and immediate transcription of speech, initiating command action without relying on a specific keyword. This recognizer becomes operational when it catches a particular phrase within the audio flow, marking the commencement of command processing.

The system operates independently of a wake-up word, constantly monitoring and recognizing speech inputs instantaneously, thus eliminating the need for any preset signal phrase. Its capability for non-stop listening facilitates the smooth processing of voice commands, making the system adaptable for myriad applications where a wake-up word might be unnecessary.

Furthermore, the system in Command Mode has the ability to identify the end of sentences without relying on a wake-up word, using various strategies embedded in its speech recognition algorithm. Key among these strategies is the analysis of pauses or breaks in speech to signify the conclusion of a sentence. It might also utilize context clues, such as the structure of the spoken message or natural language processing techniques, to determine sentence boundaries, ensuring the system's effectiveness in detecting sentence completion without a specific cue.

The system handles the recognition and transcription of prolonged sentences through its continuous, real-time monitoring for speech inputs. By identifying stops in speech patterns, it is capable of accurately transcribing long sentences without the need for a wake-up word, showcasing its adeptness in speech processing.

In Adaptive Mode, the system leverages both wake-word recognizer 162 and dynamic recognizer 164 to continuously monitor for specific wake-up words or phrases. Additionally, it incorporates a relevance-based scene recognizer 166 equipped with a decision-making module 110. This module autonomously assesses contextual significance, chooses appropriate scenes, and carries out the required commands within the connected Smart Home environment.

In some embodiments, when in Command Mode, the relevance-based scene recognition functionality is deactivated, limiting the system to executing routines initiated solely by either the wake-word recognizer 162 or the dynamic recognizer 164.

Transitioning to Command Mode occurs in Adaptive Mode when a wake word is detected, lasting for the span of the activated routine. The relevance-based scene recognition remains off during this period. Following the routine's conclusion, the system reverts to Adaptive Mode, reactivating the relevance-based scene recognizer 166.

Should the assistance prediction system in Command Mode detect a specified wake-word from the user, it shifts to Adaptive Mode. This transition from Adaptive to Command Mode isn't automatic but is instead triggered by the recognition of a specified wake-word by the user.

While in Adaptive Mode, if the wake-word recognizer 162 picks up on a wake-word, it temporarily switches the system to Command Mode for the ongoing routine, returning to Adaptive Mode afterward. During this routine's execution, relevance-based scene activation is suspended.

In Adaptive Mode, the system disables the dynamic recognizer 164, activates the wake-word recognizer 162, and enables the relevance-based scene recognizer 166.

In Command Mode, it activates both the dynamic recognizer 164 and wake-word recognizer 162 while disabling the relevance-based scene recognizer 166.

The relevance-based scene recognizer 166 in Adaptive Mode features a decision-making module 110 that independently evaluates the relevance of contexts, selects suitable scenes, and implements the commands needed across Smart Home devices interconnected with the system.

The admin client devices 102 and user client devices 106 are computing devices capable of receiving user input, displaying information to a user, and transmitting and/or receiving data via the network 120. Hereafter, a “client device” can refer to any of the admin client device 102 and user client device 106. In one embodiment, a client device may be any device having computer functionality, such as a personal digital assistant (PDA), a mobile telephone, a smartphone, a tablet computer, a desktop or laptop computer, or another suitable device. A client device is configured to communicate with the assistance prediction system 125 via the network 120, for example using a native application executed by the client device, a web browser running on the client device, or through an application programming interface (API) accessed by a native operating system of the client device.

The admin client device 102 communicates with the assistance prediction system 125 through network 120, submitting requests for and receiving information on assistance prediction, including forecasts of assistance applicability, choices from environmental adjustments to user preferences, and specific scenes designed to maximize user satisfaction and system efficiency. In one embodiment, the admin client device 102 connects to the assistance prediction system 125 using an interface 130 generated by the assistance prediction system 125. In some embodiments, the admin client device 102 gathers input from an administrator detailing the capabilities and behavioral patterns of devices within certain groups, often related to requests for predicting assistance applicability. This information regarding device capabilities and user behavior collected by the admin client device 102 is utilized by the assistance prediction system 125 to either train new assistance prediction models or refine previously trained assistance prediction models, aiming to accurately forecast the relevance of assistance and pinpoint a collection of scenes that enhance this relevance.

As used herein, a “assistance prediction model” (or “machine learning prediction model”, or simply “prediction model” hereinafter) refers to any model that uses one or more machine learning operations to predict a measure of assistance relevance based on information comprising device information, or that is trained on information comprising device information using one or more machine learning operations. In application, assistance prediction models produce assistance prediction information, including a predicted measure of assistance relevance and a set of scenes that, when performed, is expected to produce the predicted measure of assistance relevance. In practice, an assistance prediction model can use or be trained by any machine learning operation, such as those described herein, or any combination of machine learning operations for predictions of assistance relevance.

The user client device 106 communicates with the assistance prediction system 125 over the network 120 to gather insights on the predicted relevance of assistance from one or more administrators. Specifically, a user operating the user client device 106 can discern anticipated levels of assistance relevance from various administrators, encompassing a type of service offered by an administrator, the expected volume of services rendered by an administrator, and a comparison of efficiency and responsiveness among a group of administrators. Utilizing this data, a user of the user client device 106 can engage in negotiations with one or more administrators or initiate collaborations with one or more service providers.

The external databases 112 are one or more sources of data describing past or present actions, events, and characteristics associated with assistance relevance that can be used by machine learning processes of the assistance prediction system 125 to train assistance prediction models, to apply assistance prediction models to predict future assistance relevance, and to identify scenes that optimize future assistance relevance. Each external database 112 may be connected to, or accessible over, one or more wireless computer networks. External databases 112 may include one or more Web-based servers which may provide access to stored and/or real time information. In some embodiments, the assistance prediction system 125 accesses information from the external databases 112 directly.

The sensor data sources 114 serve as repositories of data collected from sensors, detailing both historical and present measurements relevant to the effectiveness of assistance, which the machine learning components of the assistance prediction system 125 utilize to train and apply models predicting the future impact of assistance and determining the most effective scenarios to enhance this impact. These data sources include information on environmental conditions, user interactions, and device performance. Each sensor data source 114 can connect to the network wirelessly, allowing seamless integration with the assistance prediction system 125 for the automatic acquisition of sensor data. Alternatively, in other embodiments, the information from sensor data sources 114 might require manual input, such as through an administrative interface provided by the system, facilitating direct data entry by administrators or users through a graphical user interface designed by the interface module 130.

Sensor data from sensor data sources 114 may be taken at one or more times at manual or automated triggers (e.g., a threshold time since a previous measurement: a request by an admin to receive a measurement). Sensor data sources 114 may be deployed across diverse locations. Sensor data sources 114 may additionally be located at fixed points or may be coupled to moving objects. In addition to sensor measurements, sensor health data and other sensor metadata can be collected for use in verifying the quality of measurement data collected by the sensors and determining the health of the sensors themselves.

The assistance prediction system 125 receives data from the external databases 112 and sensor data sources 114, and performs machine learning operations on the received data to produce one or more assistance prediction models. The data from these data sources can be combined, and a standard feature set can be extracted from the combined data, enabling assistance prediction models to be generated across different temporal systems, different spatial coordinate systems, and measurement systems. For example, sensor data streams can be a time series of scalar values linked to a specific latitude/longitude coordinate. After aggregating and standardizing data from these data streams, feature sets can be extracted and combined.

One or more machine learning operations can be performed on the calculated feature sets to produce the one or more assistance prediction models. The assistance prediction models can then be applied to data describing a group of devices in order to predict an assistance relevance for the group of devices. The assistance prediction system 125 is configured to communicate with the network 120 and may be accessed by client devices via the network such as admin client devices 102 and user client devices 106. The assistance prediction system shown in FIG. 1 includes an interface 130, a device capability database 135, an user behavioral database 140, a normalization module 145, a database interface module 150, and the assistance prediction engine 155. In other embodiments, the assistance prediction system 125 may contain additional, fewer, or different components for various applications. Conventional components such as network interfaces, security components, load balancers, failover servers, management and network operations consoles, and the like are not shown so as to not obscure the details of the system architecture.

The interface 130 facilitates all communications within the assistance prediction system 125, ensuring seamless interaction, data transmission, and reception among the various components outlined in FIG. 1 as required. In some embodiments, the interface 130 generates a user interface that can be displayed on admin client devices 102, user client devices 106, or any display connected to the assistance prediction system 125 or other systems within environment 100. This user interface provides a platform for diverse interactions with the assistance prediction system 125. In one embodiment, the interface 130 tailors its communication features to match the permissions of different user categories. For instance, it enables an admin client device 102 to query predictions on the relevance of assistance and request scenarios that maximize this relevance for devices managed by the admin, while restricting access to this sensitive information for users not authorized to manage the device. Additionally, the interface 130 grants an admin client device 102 access to a variety of scenarios enacted by various administrators and to comprehensive datasets from both the device capability database 135 and the user behavior database 140, whereas it might limit such access for a user client device 106. In other embodiments, the interface 130 is also capable of generating a visual map showcasing groups of devices, complete with icons or other markers to denote the precise locations of sensors and devices within the system's overview.

The device capability database 135 catalogs and preserves information on the functional attributes of various device groups that could influence the pertinence of assistance. In this context, a “group of devices” encompasses any collection of interconnected or related devices. For example, a “group of devices” might signify a collection managed by a single administrator, a network of smart home appliances, and similar configurations. Additionally, such a group might consist of several “clusters” of devices, denoting smaller segments within the larger group, regardless of their physical layout or size. The device capability database 135 accommodates a myriad of data types and structures, accessible to other components of the assistance prediction system 125 for executing machine learning tasks. These tasks could involve training models to anticipate the relevance of assistance for particular device groups or identifying scenarios that elevate the effectiveness of assistance. This device capability database 135 is structured in various formats, allowing for versatile data storage solutions like flat files, columnar storage, or binary formats, and is accessible through different data management systems including relational databases, columnar databases, NoSQL solutions, or horizontally scaled databases. Further exploration of the device capability database 135 and its organization is provided with reference to FIG. 2.

FIG. 2 illustrates an example device capability database 135 for a machine learning assistance prediction system. In the example database of FIG. 2, information describing device capability characteristics that may impact assistance relevance are associated with a device index that uniquely identifies a particular device associated with the characteristics. As shown in FIG. 2, the device capability database 135 associates each uniquely identified device with one or more sets of associated data (“operational status,” “environmental sensitivity,” and “user interaction patterns”).

The user behavioral database 140 collects and safeguards data detailing the behavioral patterns linked to the utilization of assistance, which could influence its perceived relevance. This encompasses a wide array of data types and structures, making them accessible for the assistance prediction system 125 to conduct various machine learning tasks. These include developing and training models to foresee the relevance of assistance for specific device groups and pinpointing scenarios that heighten the effectiveness of assistance. The organization of the user behavioral database 140 is adaptable, allowing for efficient data storage and retrieval in formats such as columnar relational databases.

In one embodiment, the user behavioral database 140 encompasses metadata outlining, for instance, a device's involvement in a particular scene, including the brand of the device or its specific customizations. When certain metadata is missing, the assistance prediction system 125 is capable of deducing the absent details from existing metadata, taking into account factors like timing, geographic location, associated events, inputs or measurements lacking metadata, the admin or device identity, and machine type among others. For example, an assistance prediction model might be calibrated using data samples where full metadata is present and then applied to those lacking complete metadata, utilizing methods such as random forest classifiers, k-nearest neighbors classifiers, AdaBoost classifiers, or Naïve Bayes classifiers. Detailed discussions on the structure and function of the user behavioral database 140 are presented with reference to FIG. 3.

FIG. 3 illustrates an example user behavioral database 140 for a machine learning assistance prediction system. In the example database of FIG. 3, information describing behavioral factors that may impact assistance relevance are associated with a device index that uniquely identifies a particular device and an assistance. As shown in FIG. 3, the agricultural database 140 identifies one or more sets of data (“usage frequency,” “preference settings,” and “interaction time stamps”) associated with a device index and an assistance.

The normalization module 145 receives data in a variety of formats from the external databases 112, sensor data sources 114, or other data sources and normalizes the data for storage in the device capability database 135 and the user behavioral database 140 and used by the assistance prediction engine 155. Due to the large number and disparate nature of prospective external data sources, data received by the normalization module 145 may be represented in a variety of different formats.

For a particular type of data, the normalization module 145 selects a common format, normalizes received data of the particular type into the common format, and stores the normalized data within the device capability database 135 and the user behavioral database 140. In addition, the normalization module 145 can “clean” various types of data, for instance by upscaling/downscaling image data, by removing outliers from quantitative or measurement data, and interpolating sparsely populated portions of datasets. Based on the data format and corresponding method of normalization, the normalization module 145 can apply one or more normalization operations.

In one embodiment, the normalization module 145 generates, maintains, and/or normalizes metadata corresponding to data received from external data sources. Such metadata can include the source of the corresponding data, the date the corresponding data was received, the original format of the corresponding data, whether the corresponding data has been modified by a user of the assistance prediction system 125, whether the corresponding data is considered reliable, the type of processing or normalization performed on the corresponding data, and other characteristics associated with the normalized data.

The database interface module 150 provides an interface between the components of the assistance prediction system 125 and the device capability database 135 and user behavioral database 140. For instance, the database interface module 150 receives normalized data from the normalization module 145 and stores the normalized data in the device capability database 135 and the user behavioral database 140. The database interface module 150 may additionally modify, delete, sort, or perform other operations to maintain the device capability database 135 and the user behavioral database 140.

Likewise, if the assistance prediction system 125 receives a request for an assistance relevance prediction from an admin client device 102 for a particular device, the assistance prediction engine 155 can request information associated with the particular device via the database interface module 150, which in turn can retrieve it from the device capability database 135 and from the user behavioral database 140. The database interface module 150 can then provide the requested and retrieved data to the assistance prediction engine 155 for use in applying the assistance prediction models to generate assistance relevance predictions.

The assistance prediction engine 155 trains and applies assistance prediction models by performing one or more machine learning operations to determine predictions for assistance relevance and corresponding sets of scenes that result in the predicted assistance relevance. The assistance prediction engine 155 can request data from the various external data sources described herein for storage within the device capability database 135 and the user behavioral database 140, and can perform the machine learning operations on the stored data. The assistance prediction engine 155 can also receive requests, for instance from an admin client device 102, to predict an assistance relevance for a particular device, a particular assistance, and a particular set of scenes. In addition to predicting the requested assistance relevance, the assistance prediction engine 155 can also identify a modified set of scenes or an alternative assistance that will optimize assistance relevance. Likewise, an admin can simply identify a group of devices and request a set of scenes to perform to optimize assistance relevance, and the assistance prediction engine 155 can apply one or more trained assistance prediction models to information associated with the identified group of devices to identify the set of scenes that optimizes assistance relevance.

The assistance prediction system 125 and other devices shown in FIG. 1 are configured to communicate via the network 120, which may include any combination of local area and/or wide area networks, using both wired and/or wireless communication systems. In one embodiment, the network 120 uses standard communications technologies and/or protocols. In some embodiments, all or some of the communication links of the network 120 may be encrypted using any suitable technique or techniques.

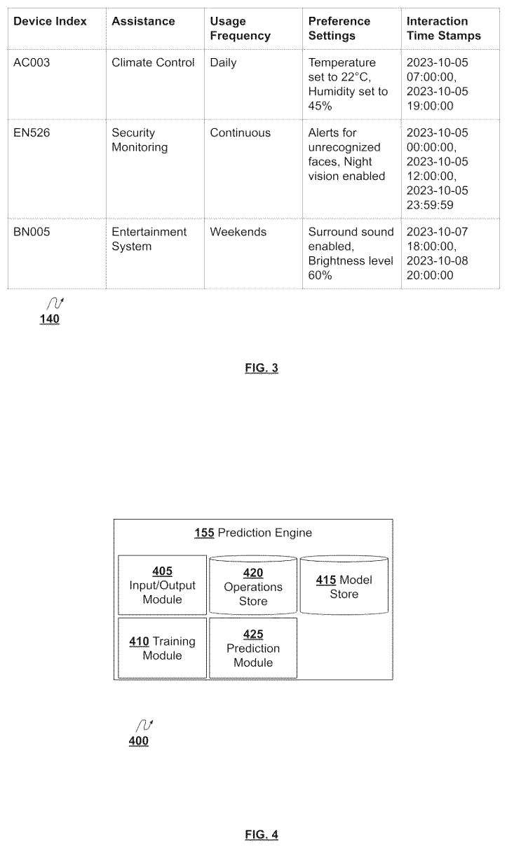

FIG. 4 is a block diagram of a machine learning assistance prediction engine 155. The assistance prediction engine 155 performs one or more machine learning operations to data from the data sources 112 and 114 of FIG. 1 to train prediction models associated with assistance relevance. The assistance prediction models, which when applied can perform one or more machine learning operations, can generate prediction information for assistance relevance, and can identify a set of scenes that, if performed, optimize assistance relevance. The assistance prediction engine 155 includes an input/output module 405, a training module 410, a model store 415, a scenes store 420, and an assistance prediction module 425. In other embodiments, the assistance prediction engine 155 may contain more, fewer, or different components than those shown in FIG. 4.

The input/output module 405 accesses information for use in training and applying assistance prediction models. For instance, the input/output module 405 receives a request from an admin client device 102 requesting assistance prediction information and including information describing a device. In another instance, the input/output module 405 accesses the device capability database 135 and the user behavioral database 140 to retrieve data for use by the training module 410 to train prediction models. The input/output module 405 can coordinate the transfer of information between modules of the assistance prediction engine 155, and can output information generated by the assistance prediction engine, for instance, assistance relevance prediction information and/or a set of scenes that optimize assistance relevance.

The training module 410 trains assistance prediction models by applying machine learning techniques to the training data retrieved from the assistance prediction system 125, notably from the device capability database 135 and the user behavioral database 140. These models are constructed using information on device functionalities, alongside user behavior data that detail how various types of assistance are utilized on the devices and the execution of scenes tailored to enhance that assistance. Additionally, it incorporates feedback information capturing the effectiveness of the implemented assistance strategies. Reflecting the comprehensive data outlined in FIGS. 2 and 3, both databases contribute insights on historical, current, and anticipated conditions influencing the relevance of assistance across different devices. The training module 410 curates a training dataset tailored to specific customizations or device settings. Following this, it undertakes several machine learning processes to discern patterns or connections within this dataset, focusing on attributes considered crucial for determining the relevance of assistance in relation to the device settings or customizations.

The training module 410 can perform various types of machine learning operations to train assistance prediction models using all or part of accessed training data or feature values of the training data as inputs to the machine learning operations. Various machine learning operations may be performed in different contexts to train the assistance prediction models, and the assistance prediction models can perform various machine learning operations when applied, including but not limited to: a generalized linear model, a generalized additive model, nonparametric regression, random forest, spatial regression, a Bayesian regression model, a time series analysis, a Bayesian network, a Gaussian network, decision tree learning, artificial neural networks, recurrent neural network, reinforcement learning, linear/non-linear regression, support vector machines, clustering operations, genetic algorithm operations, and any combination or order thereof. In one example, time series analysis operations performed by the training module 410 can include vector autoregression, ARIMA, and time-series decomposition.

The machine learning operations, when performed on input parameters describing a device or a customization, generate an assistance prediction model for the device or customization associated with the input parameters. Assistance prediction models can be generated upon receiving a request from an admin client device 102 for an assistance relevance prediction, or can be generated in advance of receiving such a request. The training module 410 stores generated assistance prediction models in the model store 415 for subsequent access and application, for instance by the assistance prediction module 425.

The training module 410 is configured to periodically update assistance prediction models under specific conditions. For example, updates may occur following a set duration since the model's last refresh, upon accumulation of a substantial amount of new training data pertinent to the model's targeted domain and personalization aspects, or after obtaining a significant quantity of device-related information within an established assistance framework. Furthermore, the training module 410 dynamically modifies an assistance prediction model in response to shifts in environmental or operational dynamics.

In some embodiments, the training module 410 can update an assistance prediction model responsive to an behavioral event. Likewise, the training module 410 can update an assistance prediction model responsive to a request received by the assistance prediction engine 155. In some embodiments, the training module 410 updates the assistance prediction models iteratively, such that an assistance prediction output from an assistance prediction model is incorporated into a training set of data used to train assistance prediction models. For example, if a prediction model generates a set of scenes identifying a customization to assistance and a date range to optimize assistance relevance, the training module 410 can incorporate the set of scenes into a training set for use in training or retraining assistance prediction models.

The model store 415 stores and maintains the assistance prediction models generated by the training module 410. In one embodiment, the model store 415 stores the assistance prediction models in association with a corresponding device index uniquely representing the device or devices of the data used to train the model. The model store 415 can also receive and store updates to the models from the training module 410, and can provide stored prediction models, for instance in response to a request from the assistance prediction module 425.

The scenes store 420 stores data describing various scenes that can be performed by an admin on a device. Scenes can be associated with sets of information including an expected impact on an assistance or a device, timing data describing when the scene should be performed, and a method of performing the scene. The scenes store 420 can provide information describing scenes for use as inputs to assistance prediction models, for instance by the assistance prediction module 425 when attempting to identify a set of scenes that optimize assistance relevance.

The assistance prediction module 425 receives a request to generate an optimized assistance relevance prediction for a device and applies one or more assistance prediction models to data associated with the device to determine a set of scenes to optimize an assistance relevance for the device. In one embodiment, the request is received from an admin via client device 102. In other embodiments, the request is received via a GUI generated by the interface module 130 and displayed on a client device of a third party, such as a technology or service provider, or a manufacturer of a good utilizing one or more behavioral inputs. In such cases, “optimizing assistance relevance” can refer to optimizing the use of a technology or service provided by such a third party, including the date and location of the use of a technology or service and any targeted device parameters associated with such use.

In certain embodiments, a request for an optimized assistance relevance forecast is generated upon satisfying conditions associated with a trigger event. Employing an assistance prediction model at varied intervals throughout a timeframe enables ongoing refinement of the scenes executed by an administrator. This approach incorporates adjustments for changes or events relevant to assistance delivery, device performance, or prevailing trends.

Responsive to receiving the request, the assistance prediction module 425 accesses device capability information associated with the field. The assistance prediction module 425 accesses the model store 415 to retrieve one or more assistance prediction models associated with the request, and applies the retrieved prediction models to the accessed device capability information. The assistance prediction models can iterate through various combinations of scenes to identify a set of scenes that optimizes for assistance relevance. In some embodiments, the type of assistance relevance that the assistance prediction models optimize for can be included within the request received by the assistance prediction module 425, can be specified by a user associated with the assistance prediction engine 155, can be a default assistance relevance type, or can be selected based on any suitable criteria.

In some embodiments, the assistance prediction model P, utilized by the assistance prediction module 425, can be depicted as:

$$assisstance prediction = P ( {device}_{1} , {device}_{2} , … {device}_{x} ; {scene}_{1} , {scene}_{2} , … {scene}_{y} )$$

Here, Equation 1 encapsulates device parameters through variables device₁, device₂, . . . , deviceₓ, and actions or scenarios through scene₁, scene₁, . . . , scene_{y}. A “device parameter” encompasses any piece of data highlighting a device's functionalities or the behavioral traits of its use, including how it interacts with the surrounding environment or contributes to the delivery of assistance. These device parameters, employed as inputs for the prediction model, might be specified in a prediction request or derived from databases such as the device capability database 135, the user behavioral database 140, or external sources. Similarly, a “scene” is defined as an act carried out by an administrator or another stakeholder aimed at enhancing the effectiveness of assistance. Requesters of prediction services can specify scenes they wish to enact, while the assistance prediction module 425 also has the capability to draw from a repository of scenes, such as those stored in the scenes store 420.

The assistance prediction module 425 applies the prediction model P to the device parameters and a set of scenes to generate a prediction of assistance relevance for the device parameters and the set of scenes. The machine learning operations performed by the assistance prediction module 425 can iterate through multiple combinations of scenes in order to identify a set of scenes that optimizes predicted assistance relevance. In some instances, the set of available scenes are constrained by the resources available to the admin. For instance, the assistance prediction module 425 can perform a random forest classifier or a gradient boosting operation to identify the set of scenes that produces the optimized assistance prediction without having to exhaustively iterate through every combination of possible scenes.

In some embodiments, assistance prediction models are applied to a particular customization, such as a customization specified by an admin. In other embodiments, the assistance prediction module 425 additionally modifies the customization when applying an assistance prediction model to determine a customization that optimizes the assistance relevance. In these embodiments, the assistance prediction module 425 identifies a customization and a set of scenes corresponding to the identified customization, for instance for display on the admin client device 102.

In some embodiments, the assistance prediction model operates as a neural network, which is trained using data related to device functionalities and user behaviors. This includes specifics like device features, types of assistance provided, scenarios enacted, and the effectiveness of the assistance delivered. This sophisticated neural network is capable of correlating various device capabilities and user actions with the levels of assistance effectiveness, even predicting outcomes for combinations not previously encountered during its training. Upon deploying this neural network within the assistance prediction module 425 against specific device configurations, it can experiment with different scene arrangements to pinpoint a collection of actions that align with the most effective assistance delivery. It's important to understand that within the context of machine learning processes and assistance prediction models discussed here, achieving an “optimized assistance relevance” signifies reaching the peak level of assistance effectiveness, as determined across a specified set of trials or over a particular period.

As previously mentioned, the assistance prediction module 425 calculates the most effective assistance relevance by evaluating various forecasts based on different combinations of scenes and device settings. In one embodiment, this module is capable of selecting a prediction for assistance relevance and the related sequence of actions that promise the highest anticipated benefit. This anticipated benefit, or utility, is assessed through several criteria, such as preferences explicitly stated via an admin client device 102, the nature of the assistance provided, the characteristics of the devices involved, among others.

The results generated by the assistance prediction models through the assistance prediction module 425 can be presented in multiple formats. In some embodiments, the assistance prediction module 425 provides an evaluation of how relevant the assistance is for a specific sequence of actions. For instance, it could deliver a numerical score indicating the anticipated level of effectiveness; a distribution of probabilities; or a graphical overlay on a map pinpointing device locations, including areas marked as priority zones based on a request, which display where various actions should be applied and the forecasted impact of these actions within those zones.

In some embodiments, the assistance prediction module 425 delivers a selection of scenes designed to maximize the relevance of assistance provided. As an example, this module might issue recommendations for a specific type of assistance to target, suggest a particular time frame for action, among other details. It's also equipped to adjust either the approach to assistance or the lineup of scenes as initially identified by an administrator, presenting these alterations, perhaps by emphasizing the changes. Regardless of the output format of the assistance prediction model, the interface 130 is capable of prompting either an admin client device 102 or any other relevant system component to exhibit the model's results. Furthermore, the assistance prediction module 425 can send a curated list of actions directly to IoT devices for execution. Additionally, the interface 130 has the flexibility to alter the display on an external device, such as the admin client device 102, to showcase a planned sequence of scenes along with the anticipated improvement in assistance effectiveness these actions are expected to bring about.

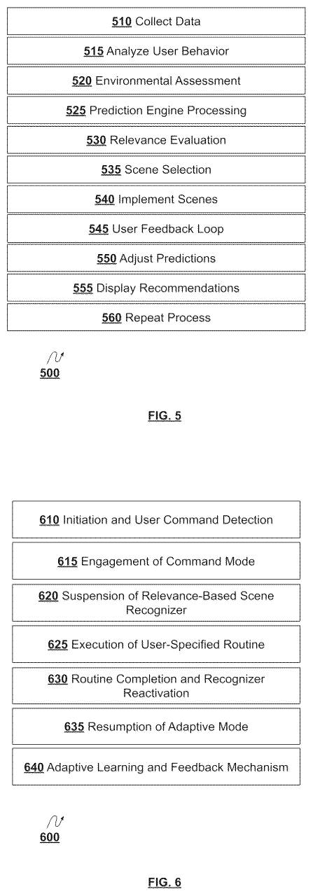

FIG. 5 is a flowchart illustrating a process for integrating a prediction engine with a relevance-based scene recognizer to dynamically optimize smart home settings based on user behavior and environmental data. This detailed description elaborates on the various steps involved in this process and how it enhances the functionality of smart home systems through the application of machine learning and context-aware computing.

Initially, the system begins by gathering comprehensive data across multiple dimensions: user behavioral patterns, including preferences and historical interactions with smart home devices, and environmental data from sensors within the home and external sources such as weather reports 510. This collection phase creates a rich dataset from which the system can learn and make informed predictions.

Subsequent to data collection, the system proceeds to analyze user behavior to uncover patterns and preferences. This analysis 515 employs advanced data analytics to decipher how users interact with their smart home environment, identifying routines and preferred settings for various devices.

In parallel, an environmental assessment 520 is conducted, analyzing data from environmental sensors within the home alongside external environmental factors. This dual analysis ensures that the system comprehensively understands both the user's internal home environment and external conditions that might influence smart home settings.

With the foundational data analyzed, the prediction engine processes 525 the combined user behavior and environmental data. Utilizing machine learning algorithms, the engine predicts future user needs and environmental adjustments, aiming to proactively set the smart home environment to meet those anticipated needs.

At step 530, the relevance-based scene recognizer examines the prediction engine's outputs. It determines the relevance of the context, giving priority to scenes and actions that match the anticipated needs and preferences.

Based on this evaluation, the system selects 535 the most appropriate smart home scenes or settings, applying the prediction model's insights to choose configurations that best match the anticipated environment and user preferences.

The implementation of selected scenes 540 automatically adjusts smart home devices, applying the scene configurations and thereby transforming the home environment in anticipation of the user's needs.

A user feedback loop 545 tracks interactions after implementation, enabling the system to collect feedback on the precision and user satisfaction regarding the automated adjustments. This feedback serves to refine future predictions.

The system then adjusts 550 its predictions and scene selections based on user feedback, employing a continuous learning approach to improve accuracy and relevance over time.

In some embodiments, the system displays recommendations and insights 555 on a user interface before automatic scene implementation. This step enhances transparency and allows users to make informed decisions about the automated settings, promoting a sense of control and trust in the system.

The process concludes with the repetition 560 of this cycle, continually updating and refining the system's understanding and predictions based on new data, user feedback, and changing environmental conditions, ensuring the smart home environment remains optimally aligned with the user's needs and preferences.

FIG. 6 illustrates a process employed by the smart home system to navigate between operational modes and manage the functionality of the relevance-based scene recognizer. The process initiates with the system's collection of data, where it identifies a user command through the integrated wake-word or dynamic recognizer 610. This detection triggers the system's readiness to transition into Command Mode, emphasizing the immediate response to user interaction.

In some embodiments, the system transitions into Command Mode 615 upon command detection. This mode is tailored for the execution of explicit user commands, directing the system's resources towards fulfilling the specified user actions promptly and accurately, thereby showcasing the system's responsive adaptability.

Inherent to Command Mode is the strategic suspension of the relevance-based scene recognizer 620. This action ensures that automated, context-aware adjustments are temporarily halted, allowing for the undisturbed execution of the user's direct command. This step is pivotal in maintaining the integrity and priority of user instructions.

Within Command Mode, the strategic suspension of the relevance-based scene recognizer 620 temporarily halts automated, context-aware adjustments. This allows the user's direct commands to be executed without interference, preserving the integrity and prioritization of user instructions.

With the scene recognizer suspended, the system proceeds to execute the user-defined routine 625. This phase highlights the system's ability to precisely adjust smart home settings according to the user's directives, reinforcing the system's commitment to user command prioritization.

Following the routine's successful execution, the system marks its completion and reactivates the relevance-based scene recognizer 630. This reactivation is instrumental in signaling the system's return to Adaptive Mode, enabling the continuation of personalized, context-aware assistance.

At step 635, the system's return to Adaptive Mode. This mode empowers the relevance-based scene recognizer to resume its functionality, applying predictive analytics to dynamically adjust smart home settings based on an amalgamation of user behavior patterns, environmental data, and the anticipated needs of the user.

The process is supported by a continuous learning mechanism that incorporates user feedback and environmental data 640. This feedback loop is critical for refining the system's predictive models and scene selection strategies, facilitating an evolving system that adapts to user needs and preferences over time.

1. A system comprising:
a processor; and
a non-transitory computer-readable storage medium storing executable instructions that, when executed by the processor, cause the processor to perform steps comprising:
accessing, for each of a plurality of smart home environments, data information describing 1) characteristics of the smart home environments, 2) a first set of scenes yet to be performed, including routine and action-based scenes, and 3) a first expected assistance relevance corresponding to the first set of scenes;
identifying a cluster of devices associated with a threshold similarity in terms of user preferences, historical behavior, and environmental conditions;
applying an incorrect prediction model and a correct prediction model both trained on historical information from a plurality of similar environments to the accessed data information associated with the cluster of devices, the incorrect prediction model selects unsuitable scenes in order to increase the likelihood of the prediction model in live action, whereas the prediction model augmented by a decision-making module that independently evaluates the relevance of contexts, selects suitable scenes, and implements the commands needed across smart home devices interconnected with the system to output an optimized prediction for a selected group of devices within the identified cluster of the devices, comprising:
1) a selected variety or type of assistance to be provided, as determined by the decision-making module based on its independent evaluation of current contexts, encompassing routine activation, scene setting, or specific actions tailored to the evaluated relevance,
2) a second set of scenes that can produce a second expected assistance relevance, selected by the decision-making module for their suitability and potential impact, and
3) the second expected assistance relevance, calculated based on the comprehensive evaluation of scene interactions, user engagement, and the autonomous decisions made by the module;
wherein the prediction is based on inputs to the prediction model comprising:
1) the characteristics of the selected group of devices,
2) the first set of scenes yet to be performed on the selected group of device, incorporating routines and actions tailored to user-specific needs and preferences, as well as the system's autonomous scene selection capabilities, and
3) the first expected assistance relevance corresponding to the first set of scenes yet to be performed on the selected group of device; and
for the selected group of devices within the identified cluster of devices, 1) modifying the first set of scenes yet to be performed on the selected group of devices based on the selected type of assistance to be implemented and the second set of scenes, as independently determined by the decision-making module, and 2) modifying a user interface displayed by a client device of the user to display a recommendation or visualization based on the modified first set of scenes and the optimized assistance strategy developed by the decision-making module, thereby enhancing user interaction with the smart home system by leveraging the system's predictive and autonomous decision-making capabilities to tailor the home environment to current and anticipated user needs.

2. The system of claim 1, wherein the prediction model comprises one or more of: a generalized linear model, a generalized additive model, a non-parametric regression operation, a random forest classifier, a spatial regression operation, a Bayesian regression model, a time series analysis, a Bayesian network, a Gaussian network, a decision tree learning operation, an artificial neural network, a recurrent neural network, a reinforcement learning operation, linear/non-linear regression operations, a support vector machine, a clustering operation, and a genetic algorithm operation.

3. The system of claim 2, further comprising:
a wake-word recognizer configured to activate specific functionalities within the smart home environments upon detection of predetermined vocal cues, serving as an initial layer of interaction for user commands;
a dynamic recognizer designed to transcribe continuous speech inputs without reliance on specific wake-word cues, enabling a broader range of command processing and interaction within the smart home environments; and
a relevance-based scene recognizer, integrated with the decision-making module, capable of evaluating the contextual significance of at least one of detected speech and environmental inputs, autonomously select and activate the most appropriate scenes or actions based on current needs and historical behavior patterns of the user;
wherein, the system transitions between utilizing the wake-word recognizer and the dynamic recognizer based on an operational mode, and the relevance-based scene recognizer is selectively activated to implement at least one of tailored smart home scenes and routines, dynamically adjusting the home environment to reflect both explicit commands and inferred user preferences.

4. The system of claim 3, wherein the operational mode of the system comprises:
a command mode, where the system prioritizes the wake-word and dynamic recognizers for direct command execution from the user; and
an adaptive mode, where the system leverages the relevance-based scene recognizer for context-aware assistance delivery, autonomously adjusting smart home scenes or routines based on evaluated contextual significance and user preferences;
wherein, the system transitions between the command mode and the adaptive mode based on the presence of specific triggers, such as the detection of a wake-word or the completion of a direct command routine, thereby enabling a seamless user experience that adapts to both explicit user inputs and implicit context cues.

5. The system of claim 4, wherein during the execution of a routine in the command mode, the system is configured to temporarily suspend the relevance-based scene recognizer to prioritize the processing and completion of direct commands initiated by the user through the wake-word and dynamic recognizers.

6. The system of claim 5, wherein the suspension facilitates focused attention on executing the predefined actions or settings constituting the routine, ensuring that immediate user commands are fulfilled without interference from the system's context-aware assistance functionalities.

7. The system of claim 6, wherein the system, upon completion of the routine, automatically resumes the operation of the relevance-based scene recognizer, transitioning back to the adaptive mode for continued context-aware assistance delivery, thereby ensuring that the smart home environment remains responsive to both the immediate and anticipated needs of the user without compromising the effectiveness of routine executions.

8. The system of claim 7, further comprising:
an evaluation mechanism within the decision-making module for assessing the effectiveness of executed scenes and routines based on user feedback and system performance metrics, enabling continuous improvement of the system's predictive accuracy and relevance-based scene selection.

9. The system of claim 8, wherein the decision-making module utilizes machine learning algorithms to adaptively refine its context evaluation criteria and scene selection process over time, based on accumulated historical data and evolving user preferences, thereby enhancing the personalized adaptability of the system.

10. The system of claim 9, further configured to:
implement a feedback loop from the smart home devices to the decision-making module, providing real-time data on device status and environment conditions, which is used to adjust scene predictions and assistance strategies dynamically, ensuring that the assistance provided remains aligned with the current state and needs of the smart home environment.
